(19) United States
(12) Patent Application Publication
(10) Pub. No.: US 2002/0071551 A1
(43) Pub. Date: Jun. 13, 2002

(54) Cellular phone electromagnetic wave earpiece shield

(76) Inventor: Dae Sun Lee, Seoul (KR)

Correspondence Address: LARSON AND LARSON, 11199 69TH STREET NORTH, LARGO, FL, 33773

(21) Appl. No.: 09/734,250

(22) Filed: Dec. 11, 2000

(51) Int. Cl. H04M 1/00

(52) U.S. Cl. 379/451

(57) ABSTRACT

A circular shield adhered over the ear holes of a cellular phone, the shield constituting a woven mesh material of polyester fibers coated with a layer of copper and a layer of nickel over the copper. The woven mesh material is enclosed between a top rim of a compressed aluminum foil and a bottom film having double-sided adhesive.

### BACKGROUND OF THE INVENTION

This invention relates to electromagnetic shielding devices. More particularly, it refers to a disc mounted over a cellular phone earpiece to shield a user's ear canal from electromagnetic waves.

Shielding for users of cellular phone to prevent injury from electromagnetic waves has been developed in the last few years. Examples of these developments are set forth in U.S. Pat. Nos. 5,335,366; 5,440,630; 5,444,866; 5,613,221; 5,657,386; and 5,819,162. It also is well known from U.S. Pat. No. 4,900,618 that electrically conductive copper-coated polyester fibers are useful as shielding material for electromagnetic radiation.

Regulation of electromagnetic waves has been tightened in the U.S.A. with the limitation on human exposure to 3 KV for an electric field, 3 mg for a magnetic field and 0.2 mV/cm for high frequency waves. One area of exposure to electromagnetic waves is the inner ear of a person listening to a cellular phone. Currently produced cellular phones have no shielding to protect the inner ear of a cellular phone user. Such shielding is needed to prevent electromagnetic waves from penetrating the inner ear of a cellular phone user.

### Summary of the Invention

The present invention solves the problem of inner ear exposure to cellular phone electromagnetic waves by eliminating such waves with a shielding device adhesively affixed to the cellular phone ear holes. The shielding device is a woven mesh material in the form of a circle having closely woven multiple polyester fibers coated with a layer of copper and a layer of nickel over the copper. The woven mesh material is enclosed on a top surface with a circular rim of compressed aluminum foil and on a bottom surface with a double-sided adhesive ring adapted to adhere to the cellular phone earpiece.

### BRIEF DESCRIPTION OF THE DRAWINGS

This invention can be best understood by those having ordinary skill in the art by reference to the following detailed description when considered in conjunction with the accompanying drawings in which:

FIG. 1 is a perspective view of the woven mesh shielding device for cellular phones of this invention.

FIG. 2 is a cross section of the shielding device of FIG. 1 along lines 2-2.

FIG. 3 is an exploded view of the shielding device.

FIG. 4 is a magnified view of the polyester fibers forming the shielding mesh.

FIG. 5 is a perspective partially in section of the coated polyester fiber forming the shielding mesh.

FIG. 6 is a side view in cross section of the shielding device being lifted from its backing.

FIG. 7 is a front view of a cellular phone with the shielding device affixed over the ear holes.

### DETAILED DESCRIPTION OF THE INVENTION

Throughout the following detailed description, the same reference numerals refer to the same elements in all figures.

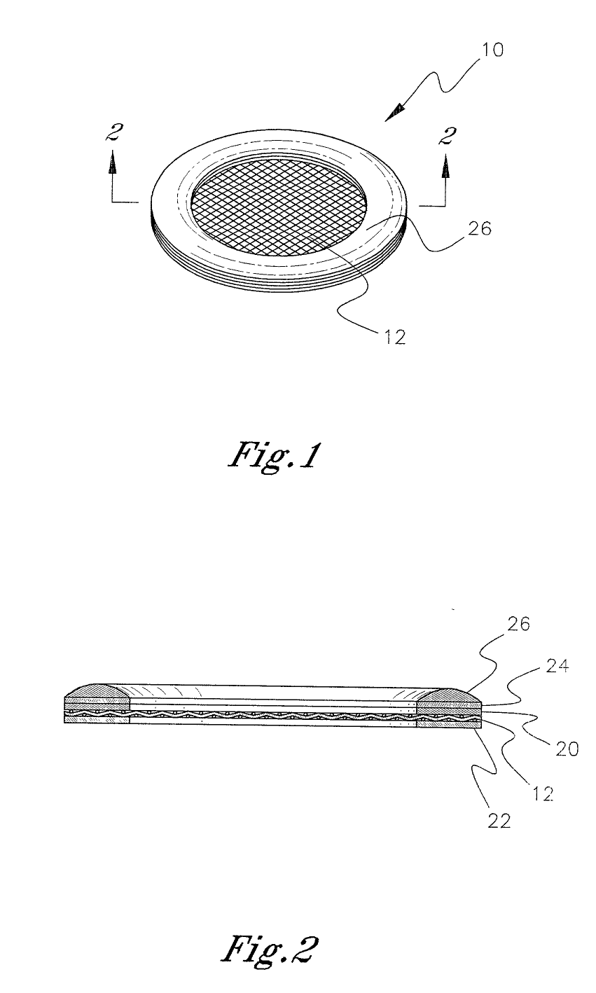

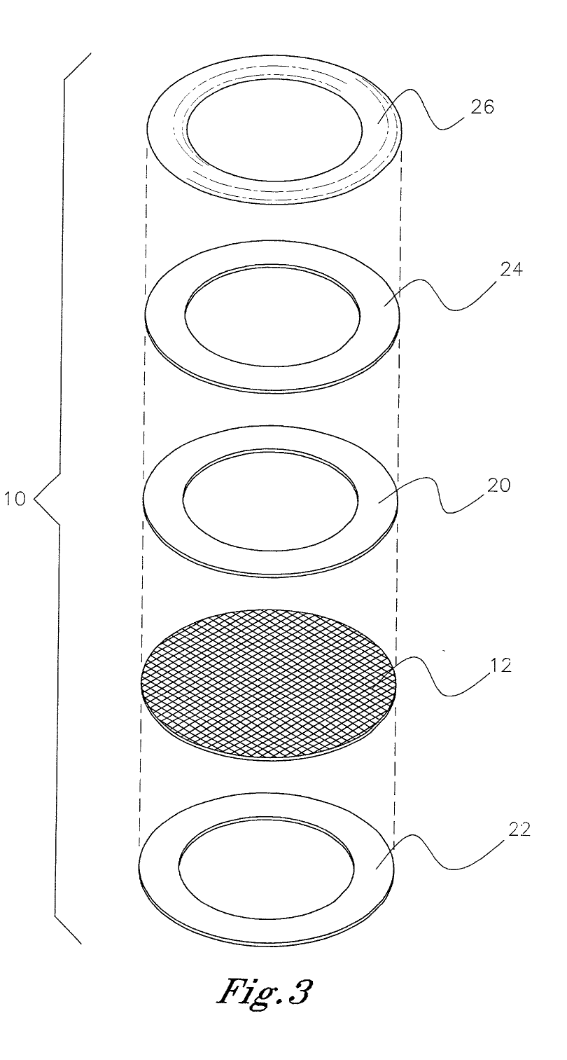

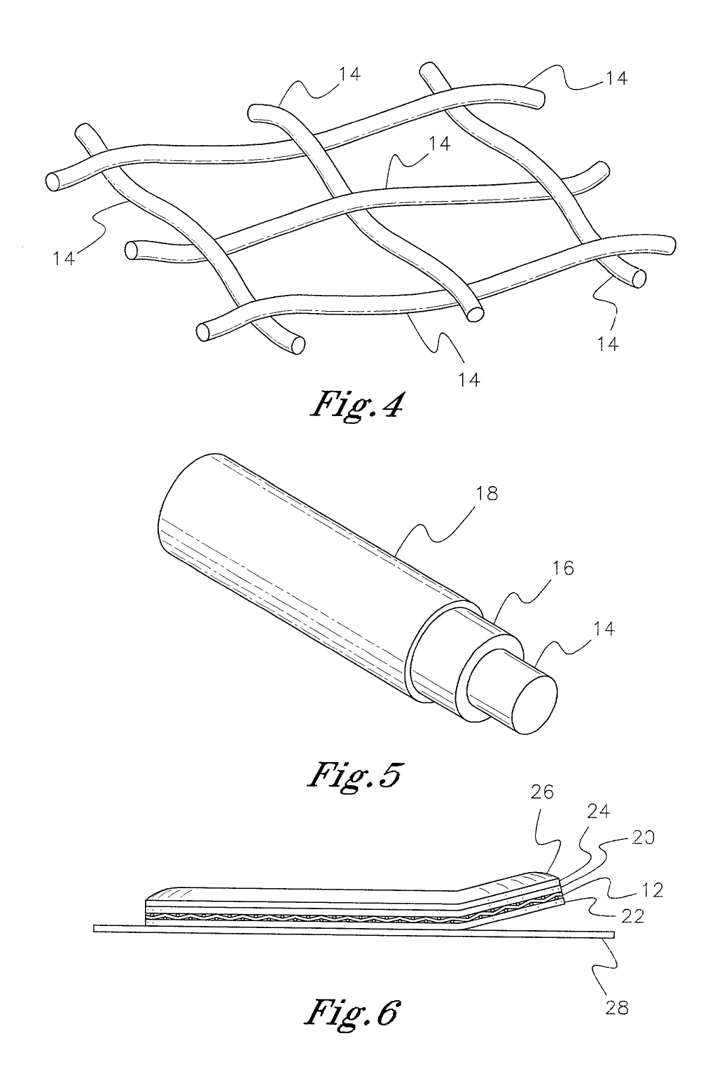

The cellular phone electromagnetic wave earpiece shield 10 is shown in FIGS. 1-3 and 6-7. Referring to FIGS. 3-5, the shield 10 has a main mesh component 12 that is circular in configuration and is made from tightly woven strands of polyester fiber 14 coated with copper 16 and overlaid with nickel 18. The weave creates a sheen known as taffeta.

A first top ring 20 and a second bottom ring 22 of a double-sided adhesive tape encloses a rim portion or periphery of the mesh 12. A pressed aluminum ring 24 forms a frame member for the shield 10 over a top surface of the first ring 20 and an epoxy resin 26 coats the top of the pressed aluminum ring 24.

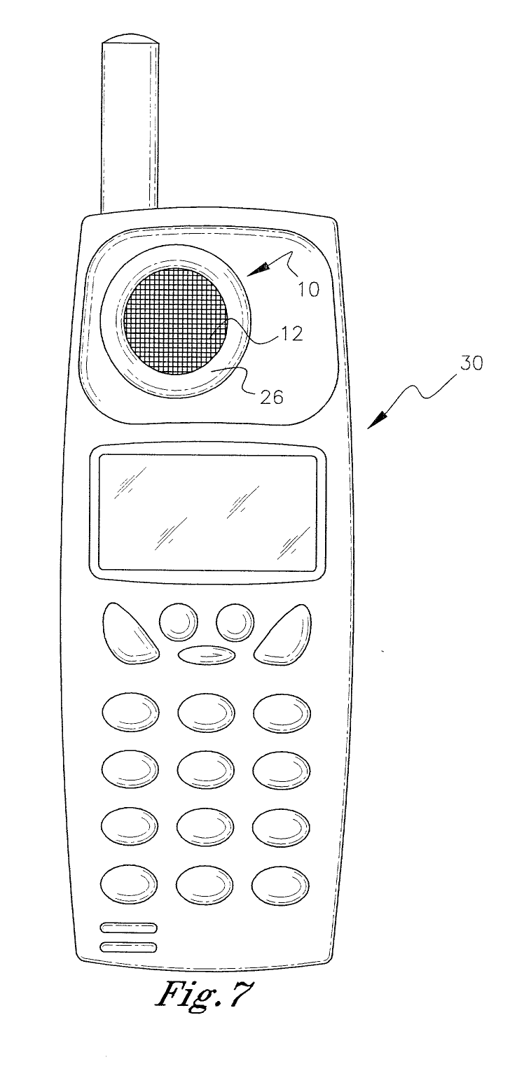

A strip of polymer film 28 shown in FIG. 6 is provided so that multiple shields 10 can be easily attached to the film 28 by removable adhesive. The shield 10 bottom adhesive layer 22 bottom surface, is removed from the film 28 and thereafter the shield 10 is attached by the same bottom surface to a cellular phone 30 over its earpiece as shown in FIG. 7.

The preferred mesh 12 is trademarked SHIELDRON® purchased from ELECTRO MAGNETIC SOLUTIONS, INC. and is known as DEI-190. SHIELDRON® is a taffeta mesh of tightly woven polyester strands coated with copper and nickel employing an electroless coating procedure. The DEI-190 mesh provides a 99.999% exclusion of electromagnetic waves impinging on the mesh 12 surface. The epoxy resin employed contains bisphenol, polypropylene glycol, nonylphenol and a hardener. The double-sided tape 20 and 22 can be purchased from the 3 M CORPORATION as a film and cut to size as needed.

The above description has described specific structural details embodying the invention. However, it will be within one having ordinary skill in the art to make modifications without departing from the spirit and scope of the underlying inventive concept of the shielding device over a cellular phone earpiece. The inventive concept is not limited to the described invention, but includes such modifications and equivalents as would be known to persons of ordinary skill in the art.

Having described the invention, what is claimed is:

1. A shielding device for use over the earpiece openings on a cellular phone comprising:
a woven mesh material consisting of polyester fibers coated with a layer of copper and a layer of nickel over the copper;
the woven mesh material enclosed on a top surface rim with a first double-sided adhesive tape and on a bottom surface rim with a second double-sided adhesive tape adapted to adhere to the cellular phone earpiece and a top surface of the first double-sided tape adhesively attached to a pressed aluminum foil.

2. The shielding device according to claim 1 wherein the woven mesh is a taffeta material.

3. The shielding device according to claim 1 wherein a top surface of the pressed aluminum foil is covered by an epoxy resin.

4. A device for shielding the inner ear of a cellular phone user from electromagnetic waves comprising:
a shielding device mounted over the earpiece of a cellular phone;
the shielding device having a woven mesh conductive material sandwiched between a first and second double-sided adhesive tape, the first and second tape adhesively attached to a rim portion of the woven mesh conductive material on a top and bottom of the rim portion respectively;
a stiffening member ring adhesively attached to a top surface of the first tape;
an epoxy resin enclosing the stiffening member and a bottom surface of the second adhesive tape adhesively attached to the cellular phone earpiece.

5. The device of claim 4 wherein the woven mesh conductive material comprises polymer fiber coated with copper.

6. The device of claim 5 wherein the polymer fiber is a polyester fiber.

7. The device of claim 5 wherein the copper is coated with nickel.

8. The device of claim 4 wherein the stiffening member ring is a compressed aluminum foil.

9. The device of claim 8 wherein the compressed aluminum foil is coated with an epoxy resin.

10. The device of claim 4 wherein the woven mesh is a taffeta weave.
